(19) United States
(12) Patent Application Publication
(10) Pub. No.: US 2009/0183377 A1
(43) Pub. Date: Jul. 23, 2009

(54) DUST SHROUD FOR CIRCULAR SAWS

(76) Inventors: Michael Loveless, Price, UT (US); Spencer Loveless, Price, UT (US)

Correspondence Address: BATEMAN IP LAW GROUP, P.O. BOX 1319, SALT LAKE CITY, UT, 84110, US

(21) Appl. No.: 12/357,287

(22) Filed: Jan. 21, 2009

Related U.S. Application Data
(60) Provisional application No. 61/022,460, filed on Jan. 21, 2008.

(51) Int. Cl. B27B 9/00

(52) U.S. Cl. 30/390

(57) ABSTRACT

A circular saw dust shroud extends around the open portion of the blade guard to enclose the saw blade. The dust shroud provides improved dust collection while still allowing unimpeded use of the saw.

### RELATED APPLICATIONS

The present application claims the benefit of U.S. Provisional Application Ser. No. 61/022,460, filed Jan. 21, 2008, which is expressly incorporated herein by reference in its entirety.

### BACKGROUND OF THE INVENTION

1. The Field of the Invention

The present invention relates to dust shrouds. More specifically, the present invention relates to a dust shroud for circular saws.

2. State of the Art

Effective dust shrouds are desirable for multiple reasons. Circular saws, for example, are commonly used for cutting wood, stone, concrete, or other materials. Without a dust shroud, fine dust and debris is scattered over a wide area. It is desirable to contain the dust and debris which is created for several reasons. It is desirable to contain the dust and debris to keep the workplace cleaner and to minimize the time necessary to clean up afterwards as well as to reduce the health risk to the person operating the tool and others who may be nearby.

The fine dust which is often created while cutting can be quite difficult to clean up afterwards. Fine dust will float through the air for a considerable distance, requiring a large area of cleanup. The fine dust will also get into cracks and crevices, making the cleanup more laborious and difficult. The dust and debris will often get into the tool itself, causing premature failure of the bearings, motor, etc. It is thus desirable to collect the dust and debris as it is generated and prevent it from spreading to both ease cleanup and to extend tool life.

Additionally, many types of dust and debris such as concrete dust pose a health risk to the machine operator and others who may breathe it. While many types of dust such as wood dust are not viewed as overly harmful to the health, they still deposit in the lungs and require the body to work to remove the dust. Other types of dust such as concrete dust or rock dust will contain silica and other compounds or chemicals which are harmful to the lungs themselves in addition to causing the body to work to remove the same from the lungs. It is desirable to collect the dust and debris generated from a circular saw to minimize any exposure and the associated health risks.

Collecting the dust and debris as it is generated helps to reduce the amount of dust and debris which must be cleaned up afterwards and reduces the workers exposure to the dust. Some attempts have been made to collect dust from circular saws with a vacuum. While an improvement over not using a shroud, available shrouds often leave significant portions of dust and debris behind and still allow a significant portion of the dust to become dispersed in the air.

There is thus a need for a dust shroud for circular saws which is more effective at capturing the dust and debris which is created during use of the saw.

### SUMMARY OF THE INVENTION

It is an object of the present invention to provide an improved circular saw dust shroud.

According to one aspect of the invention, a dust shroud is provided which encloses the saw blade so as to better collect dust. The dust shroud encloses the saw blade without being obtrusive to the user of the saw and reducing the utility of the saw.

According to another aspect of the invention, a dust shroud is provided which does not interfere with the operation of the saw, including adjusting the depth of cut. The dust shroud allows the depth of cut to be adjusted without restriction and without losing effectiveness in collecting the dust and debris generated by the saw.

These and other aspects of the present invention are realized in a circular saw dust shield as shown and described in the following figures and related description.

### BRIEF DESCRIPTION OF THE DRAWINGS

Various embodiments of the present invention are shown and described in reference to the numbered drawings wherein:

FIG. 1 shows a perspective view of a circular saw known in the prior art;

FIG. 2 shows a perspective view of the circular saw of FIG. 1 with a dust shroud according to the present invention;

FIG. 3 shows a perspective view of the dust shroud of FIG. 1;

FIG. 4 shows another perspective view of the dust shroud of FIG. 1;

FIG. 5 shows another perspective view of the shroud of FIG. 1; and

FIG. 6 shows another perspective view of the shroud of FIG. 1.

It will be appreciated that the drawings are illustrative and not limiting of the scope of the invention which is defined by the appended claims. The embodiments shown accomplish various aspects and objects of the invention. It is appreciated that it is not possible to clearly show each element and aspect of the invention in a single figure, and as such, multiple figures are presented to separately illustrate the various details of the invention in greater clarity. Similarly, not every embodiment need accomplish all advantages of the present invention.

### DETAILED DESCRIPTION

The invention and accompanying drawings will now be discussed in reference to the numerals provided therein so as to enable one skilled in the art to practice the present invention. The drawings and descriptions are exemplary of various aspects of the invention and are not intended to narrow the scope of the appended claims.

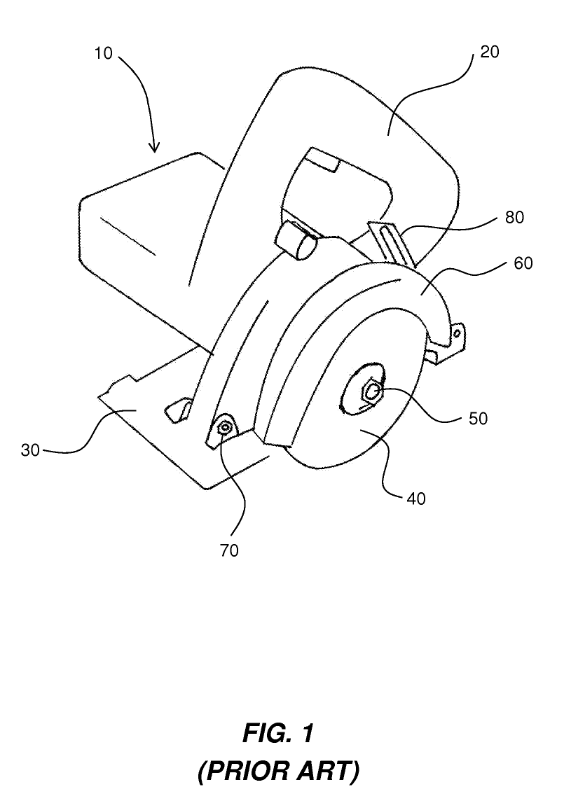

Turning now to FIG. 1, a perspective view of a hand held circular saw 10 known in the prior art is shown. The circular saw 10 includes a handle 20 to grip and direct the saw. The saw 10 also includes a table 30, blade 40 attached to motor shaft 50, and a blade guard 60 as are commonly used with circular saws. As is common with circular saws, the table 30 is mounted to the saw 10 at a front pivot 70 and includes a slotted tab 80 to lock the position of the table and thereby allow a user to select a desired depth of cut.

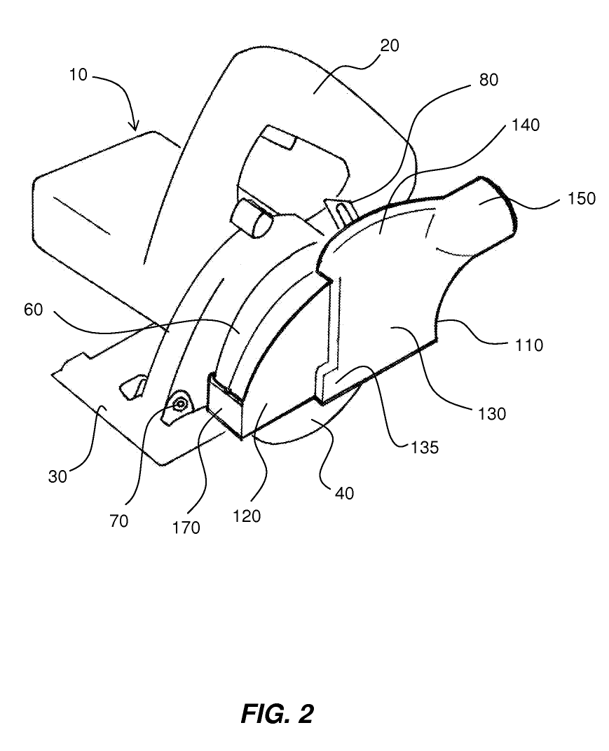

Turning now to FIG. 2, a perspective view of the circular saw 10 with a shroud 110 of the present invention is shown. The shroud 110 is designed to enclose the open side of the blade guard 60. Thus, the shroud 110 includes a front side plate portion 120 that contacts the blade guard 60 and a rear side plate portion 130 that encloses the rear portion of the blade guard 60. The rear side plate portion 130 may be disposed outwardly from the front side plate portion 120 so as to provide a larger air space around the back of the blade and thereby improve the air flow around the back of the blade and towards the vacuum port 150. This improves the dust collection abilities of the shroud 110. The rear side plate portion 130 may also include an area 135 disposed around the motor shaft 50 and disposed outwardly so as to ensure that the motor shaft does not contact the dust shroud 110.

The dust shroud 110 may also include a raised rear portion 140 adjacent a vacuum port 150 to improve the collection of dust and debris. The raised rear portion extends above the blade guard 60, forming an air space above the blade guard. The vacuum port 150 is configured for connection to a common vacuum hose, such as a 1.25 inch vacuum hose.

The use of a rear side plate portion 130 which is extended to provide an enlarged air space and a raised rear portion 140 connecting to the vacuum port 150 advantageously improves dust collection by directing and increasing the airflow around the blade 40 and towards the vacuum port. Available dust shrouds for circular saws do not enclose the blade, but instead provide a small mount for a vacuum hose near the rear of the blade. The dust shroud 110 typically requires that a custom shroud be made for each desired make of circular saw, and somewhat obscures vision of the blade while cutting, but significantly increases the amount of dust which is captured and collected. The improvement in dust collection ability is especially important in the context of stone or concrete cutting where the dust and debris is more difficult to clean up and more harmful to the lungs.

The dust shroud 110 includes a front clip 170 which extends around the front of the blade guard 60 to secure the front of the shroud. It will be appreciated that a bolt or the like may be used instead of a clip 170 depending on which particular saw the shroud 110 is designed for. The rear portion of the shroud 110 is typically attached with the bolt used to lock the table position and depth of cut.

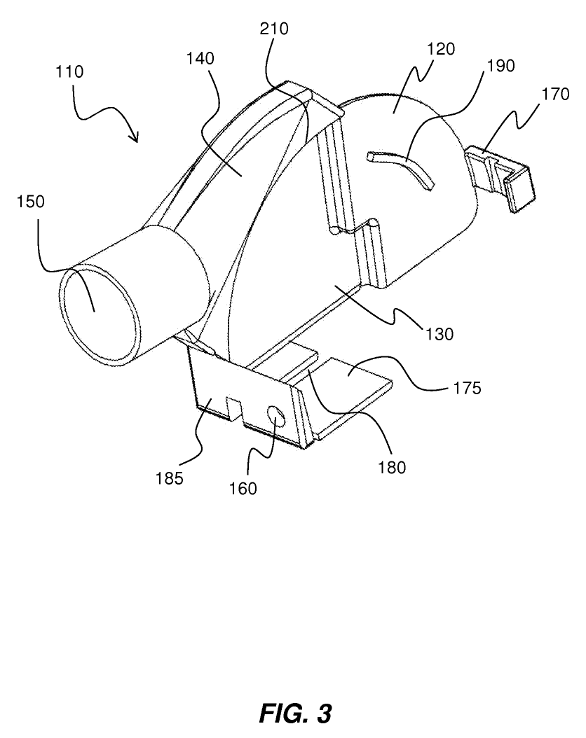

Turning now to FIG. 3, a perspective view of the shroud 110 is shown. The inside portion of the shroud 110 which faces towards the blade is shown. The shroud 110 is typically attached to the circular saw 10 (not shown) through a fastener such as the bolt used to adjust table position (not shown). The bolt may be removed from the saw 10, passed through a hole 160 formed in the shroud 110, and reattached to the saw to secure the table 30. The combination of the front clip 170 and the rear bolt hole 160 allow a user to securely and easily attach the shroud 110 to a circular saw 10 without interfering with the blade depth adjustment and use of the saw. The dust shroud 110 may also include a vane or raised post 190. The vane 190 may both aid in directing air flow and prevent accidental contact between the shroud 110 and the outer edge of the saw blade 40 if the shroud if pressed inwardly towards the blade. If the front portion 120 of the side of the shroud 110 is pressed inwardly with sufficient force to bend the shroud, the vane 190 would contact the side of the blade 40 at a location which does not have teeth or cutouts, protecting both the user and the shroud from contact with the blade teeth.

The shroud 110 includes a horizontal rear plate 175 which includes a slot 180 formed therein. The saw blade 40 fits within the slot 180 so that the plate 175 extends around the rear portion of the saw blade. Additionally, a rear wall 185 is provided which extends behind the blade 40 and provides mounting hole 160. The gap between the back of the saw blade 40 and the plate 175 is typically smaller than the gap between the saw table 30 and the blade. As such, the plate 175 and rear wall 185 help to keep dust from being carried out of the shroud 110 by the blade.

It can be seen how the vacuum port 150 is not placed near the table 30 at the very front or back of the blade 40, but is placed up above the blade along the blade guard. The placement of the vacuum port and the structure of the shroud, including the offset rear side portion 130 and raised portion 140, result in improved air flow around all of the blade and result in improved dust collection.

The circular saw 10 is typically used for cutting granite countertops or concrete. Typically, the maximum cut depth is used to cut completely through a countertop to create a sink opening or the like. When the table 30 is positioned to provide a maximum depth of cut, the plate 175 is placed against the table and the shroud 110 encloses nearly all of the blade 40 except for the bottom portion extending below the table and used for cutting. Thus, when used for cutting stone, the shroud design is most effective in capturing the dust and debris. When the table 30 is moved away from the shaft 50, pivoting around pivot 70 (FIG. 1), in order to reduce the cut depth, the plate 175 and rear wall 185 help to keep debris from exiting the shroud 110 even through a gap is formed between the shroud and the table. Thus, the shroud 110 is effective in collecting the dust and debris even if the cut depth is reduced.

It can be seen how the front side plate portion 120 is configured to rest against the side of the blade guard 60 while the raised rear portion 140 extends around the side of the blade guard with a space therebetween and rests against the top of the blade guard. This space between the rear portion 140 and the blade guard 60 forms an enlarged space for air flow as has been discussed, promoting increased air flow around all parts of the blade 40 and thereby improving the dust collection abilities of the shroud 110.

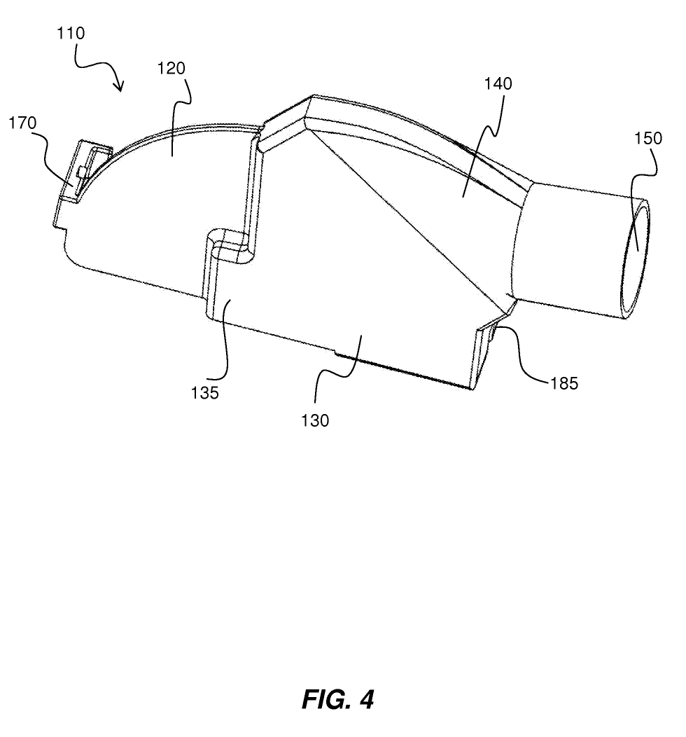

Turning now to FIG. 4, a perspective view of the external side of the shroud 110 is shown. It can more easily be seen that the front side plate portion 120 and rear side plate portion 130 of the shroud 110 may be offset laterally from each other. It can also be seen how the shroud 110 encloses the blade and open portions of the blade guard to more effectively contain and collect dust and debris generated while cutting with the saw 10.

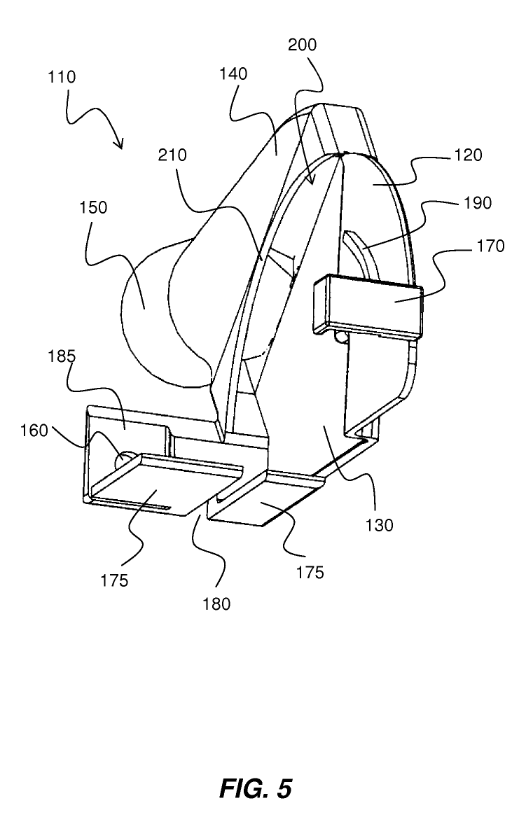

Turning now to FIG. 5, a front perspective view of the shroud 110 is shown. FIGS. 3 and 5 show how the raised rear portion 140 is enclosed on the top and sides and how it provides an opening 200 for air to flow from adjacent the blade 40 and to the vacuum port 150. The raised rear portion has a curved edge 210 which is placed against the blade guard 60 to form and enclosure around the blade 40. The opening 200 is elongate to better distribute the airflow between the front and back of the blade 40, helping to remove debris from around the blade.

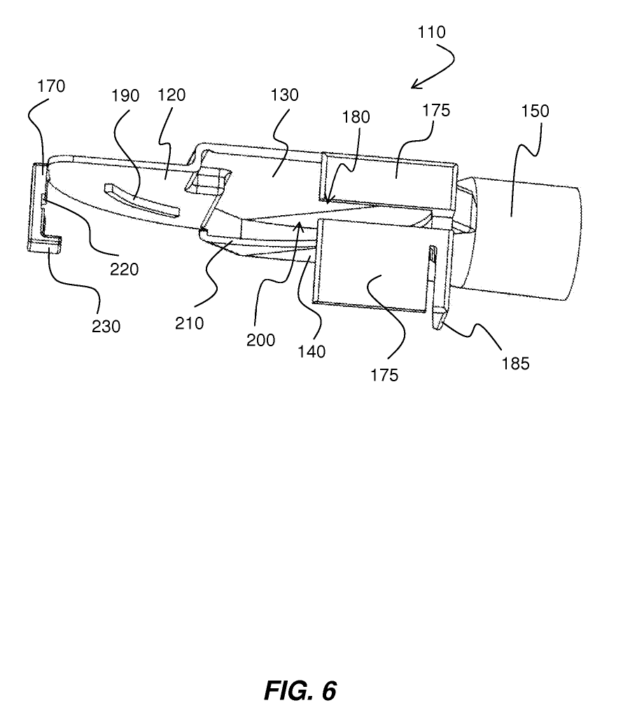

Turning now to FIG. 6, a bottom perspective view of the shroud 110 is shown. It can be seen how the front clip 170 may include a notch 220 to engage a ridge on the blade guard 60 and better secure the shroud. The front clip 170 will also typically include a flange 230 which extends around the blade guard 60 to secure the shroud 110.

The shroud 110 is designed to have minimal impact on the use of the circular saw 10 (not shown). The shroud 110 is relatively thin and as such protrudes minimally from the circular saw 10 (not shown). The shroud 110 is also simple to connect to the saw 10 while still providing a secure attachment. When the shroud 110 is attached to the saw 10, the saw may still be adjusted for depth of cut and used without hindrance.

Prior art dust shrouds for circular saws are less effective for various reasons. Because most circular saws are up-cutting saws (the blade rotates so as to move upwardly through the material at the front of the blade), prior shrouds place a vacuum port near the front of the blade to capture dust at the point of formation. The vacuum port is generally oriented to point towards the side of the blade near the blade teeth. A fair amount of debris is not captured by the vacuum port, presumably because much of the debris is disposed on the opposite side of the saw blade relative to the vacuum port. Other dust shrouds try to capture more dust and debris by forming a rather large and unwieldy shroud around the base or blade of the saw. These shrouds, overly interfere with the operation of the saw.

The present invention, however, provides a shroud where the vacuum port is near the upper back of the blade guard, away from the point of dust generation. The location of the vacuum port, combined with the design of the shroud, improve the collection of dust and debris. The shroud encloses the blade to keep dust from escaping, and places the vacuum port tangential to the blade, providing a dust shroud which draws debris from both sides of the blade. The inventive shroud allows the debris to better separate from the blade teeth before reaching the vacuum port, and has proved more effective in capturing the debris.

There is thus disclosed an improved dust shroud for circular saws. It will be appreciated that numerous changes may be made to the present invention without departing from the scope of the claims.

What is claimed is:

1. A dust shroud for a circular saw comprising:
a side plate configured for engaging the blade guard of a circular saw so as to generally enclose the portion of the blade of the circular saw which does not extend below the table of the circular saw;
a vacuum port disposed such that a vacuum hose connected thereto will draw air from around the blade of the circular saw;
a front mount configured for attaching the front of the shroud to the circular saw; and
a rear mount configured for attaching the rear of the shroud to the circular saw.

2. The dust shroud of claim 1, wherein the front mount comprises a clip which is configured to extend around a portion of the blade guard.

3. The dust shroud of claim 1, wherein the rear mount is configured for attachment to the circular saw via a bolt which is used to fix the table position and blade depth of the circular saw.

4. The dust shroud of claim 1, wherein the side plate comprises a front half and a rear half, and wherein the rear half is disposed in a position laterally outward from the front half.

5. The dust shroud of claim 4, wherein the front half engages the side of the blade guard and the rear half engages the top of the blade guard.

6. The dust shroud of claim 4, wherein the rear half extends upwardly above the blade guard and engages the top of the blade guard so as form an air chamber between the rear half and the blade guard.

7. The dust shroud of claim 6, wherein the vacuum port is attached to said upwardly extending portion of the rear half of the side plate.

8. The dust shroud of claim 1, further comprising a vane extending from the side plate towards the blade.

9. The dust shroud of claim 1, further comprising a generally horizontal plate extending inwardly towards the blade from the back of the side plate, said horizontal plate having a slot formed therein so as to extend around the blade.

10. The dust shroud of claim 9, further comprising a generally vertical plate extending vertically from said generally horizontal plate.

11. The dust shroud of claim 9, wherein said generally horizontal plate is disposed above the circular saw table.

12. A dust shroud for a circular saw comprising:
a side plate configured for extending across the blade guard of a circular saw so as to cover the upper portion of the blade thereof, the side plate comprising a front portion disposed adjacent the blade guard and a rear portion disposed laterally outwardly from the blade guard so as to be spaced therefrom;
an upper rear portion extending from the rear portion of the side plate to the blade guard;
a vacuum port disposed so as to draw air from between the blade and the side plate; and
a mount for securing the dust shroud to the circular saw.

13. The dust shroud of claim 12, wherein the upper rear portion extends above the blade guard and contacts the top of the blade guard.

14. The dust shroud of claim 13, wherein the vacuum portion is disposed on the upper rear portion.

15. The dust shroud of claim 12, wherein the mount comprises a front clip which extends around the blade guard and a rear mount which is attached to the circular saw via a blade depth adjustment bolt.

16. The dust shroud of claim 12, further comprising a horizontal plate extending inwardly from the rear of the side plate, the horizontal plate having a slot formed therethrough, the slot being configured to receive the blade such that the horizontal plate extends around the blade on both sides of the blade.

17. The dust shroud of claim 16, further comprising a generally vertical plate extending upwardly from the generally horizontal plate.

18. The dust shroud of claim 16, wherein the horizontal plate is disposed above a table of the circular saw.

19. The dust shroud of claim 12, further comprising a vane extending inwardly towards the blade of a circular saw from the side plate.
